(19) United States
(12) Patent Application Publication
(10) Pub. No.: US 2026/0151705 A1
(43) Pub. Date: Jun. 4, 2026

(54) Multispawn

(71) Applicant: Metacore Games Oy, Helsinki (FI)

(72) Inventors: Teppo SOININEN, Helsinki (FI); Petrik SANDBERG, Helsinki (FI); Tuomas TORATTI, Helsinki (FI); Saara MÄKINEN, Helsinki (FI)

(21) Appl. No.: 18/967,723

(22) Filed: Dec. 4, 2024

(51) Int. Cl. A63F 13/58; G06T 13/00

(52) U.S. Cl. CPC A63F 13/58; G06T 13/00

(57) ABSTRACT

A method, computer program, and mobile device for detecting a user input with the mobile device, and responsively automatically performing all of the following on the mobile device: generating a plurality of merge items; and displaying the generated merge items on a display of the mobile device in a merge board including a finite number of merge item positions so that at most one merge item is displayed in each one of the dedicated merge item positions.

### TECHNICAL FIELD

The present disclosure generally relates to a digital merge game engine. The disclosure relates particularly, though not exclusively, to an ergonomically optimised digital game engine.

### BACKGROUND

This section illustrates useful background information without admission of any technique described herein representative of the state of the art.

There are digital merge games in which two merge items are spawned and then merged together for forming other game objects. Forming of high-level merge items may require a significant number of spawning and merging operations, which may be time consuming and unergonomic. Along with time, also energy is consumed by extending the time it takes to play a game and keep a digital device running with a display on. However, for playing a game, it is essential not to skip the actual process of a game so as not to spoil the fun.

It is desirable to improve the ergonomics and reduce effort of game player and energy consumption of a gaming device on playing a merge game.

### SUMMARY

According to a first example aspect there is provided a method comprising
detecting a user input with a mobile device, and responsively automatically performing all of the following on the mobile device:
generating a plurality of merge items; and
displaying the generated merge items on a display of the mobile device in a merge board comprising a finite number of merge item positions so that at most one merge item is displayed in each one of the dedicated merge item positions.

According to a second example aspect there is provided a method comprising
displaying a plurality of merge items displayed in a merge board comprising a finite number of merge item positions so that at most one merge item is displayed in each one of the dedicated merge item positions; and automatically performing a process comprising:
identifying a plurality of subsets of identical merge items in the displayed plurality of merge items; and
merging the displayed plurality of subsets of identical merge items into respective merged items at a position of the merge board in which one of the merge items of the subset in question was displayed.

The process may further comprise displaying the merged items and vacating the merge item positions of the merge items that were merged.

The process may further comprise repeating the identifying the plurality of subsets of identical merge items in the displayed plurality of merge items and the subsequent acts up to an including this repeating until at least one of stopping condition is satisfied.

According to a third example aspect there is provided a computer program comprising computer executable program code which when executed by at least one processor causes a mobile device at least to perform the method of the first example aspect.

According to a fourth example aspect there is provided a computer program comprising computer executable program code which when executed by at least one processor causes a mobile device at least to perform the method of the second example aspect.

According to a fifth example aspect there is provided a computer program product comprising a non-transitory computer readable medium having the computer program of the third example aspect stored thereon.

According to a sixth example aspect there is provided a computer program product comprising a non-transitory computer readable medium having the computer program of the fourth example aspect stored thereon.

According to a seventh example aspect there is provided a mobile device comprising means for performing the method of the first example aspect.

According to an eighth example aspect there is provided a mobile device comprising means for performing the method of the second example aspect.

The means for performing the method of the first or second example aspect may comprise at least one processor configured to execute instructions or software code so that the performing of the method is caused.

Any foregoing memory medium may comprise a digital data storage such as a data disc or diskette; optical storage; magnetic storage; holographic storage; opto-magnetic storage; phase-change memory; resistive random-access memory; magnetic random-access memory; solid-electrolyte memory; ferroelectric random-access memory; organic memory; or polymer memory. The memory medium may be formed into a device without other substantial functions than storing memory or it may be formed as part of a device with other functions, including but not limited to a memory of a computer; a chip set; and a sub assembly of a mobile device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 shows a block diagram of a mobile device of an example embodiment;

FIG. 2 shows a schematic view of a merge board of an example embodiment;

FIGS. 3 to 20 show schematic views of the merge board at different times;

FIGS. 21 and 22 show flow charts of different example embodiments; and

FIGS. 23 to 38 show screenshots illustrating various phases of generating and merging merge items.

### DETAILED DESCRIPTION

In the following description, like reference signs denote like elements or steps.

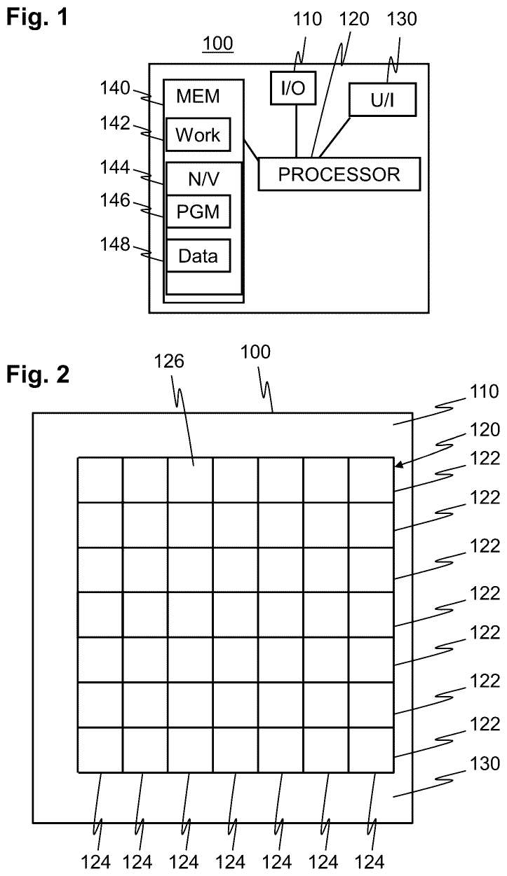

FIG. 1 shows a block diagram of a mobile device 100 according to an example embodiment. In an example embodiment, the mobile device 100 is a handheld device, such as a mobile phone, electronic game device, or tablet computer.

The mobile device 100 comprises a communication interface 110; a processor 120; a user interface 130; and a memory 140.

The communication interface 110 comprises in an embodiment a wired and/or wireless communication circuitry, such as Ethernet; Wireless LAN; Bluetooth; GSM; CDMA; WCDMA; LTE; and/or 5G circuitry. The communication interface can be integrated in the mobile device 100 or provided as a part of an adapter, card or the like, that is attachable to the mobile device 100. The communication interface 110 may support one or more different communication technologies. The mobile device 100 may also or alternatively comprise more than one of the communication interfaces 110.

In this document, a processor may refer to a central processing unit (CPU); a microprocessor; a digital signal processor (DSP); a graphics processing unit; an application specific integrated circuit (ASIC); a field programmable gate array; a microcontroller; or a combination of such elements.

The user interface may comprise a circuitry for receiving input from a user of the mobile device 100, e.g., via a keyboard; graphical user interface shown on the display of the mobile device 100; speech recognition circuitry; or an accessory device; such as a headset; and for providing output to the user via, e.g., a graphical user interface or a loudspeaker.

The memory 140 comprises a work memory 142 and a persistent memory 144 configured to store computer program code 146 and data 148. The memory 140 may comprise any one or more of: a read-only memory (ROM); a programmable read-only memory (PROM); an erasable programmable read-only memory (EPROM); a random-access memory (RAM); a flash memory; a data disk; an optical storage; a magnetic storage; a smart card; a solid-state drive (SSD); or the like. The mobile device 100 may comprise a plurality of the memories 140. The memory 140 may be constructed as a part of the mobile device 100 or as an attachment to be inserted into a slot; port; or the like of the mobile device 100 by a user or by another person or by a robot. The memory 140 may serve the sole purpose of storing data or be constructed as a part of a mobile device 100 serving other purposes, such as processing data.

A skilled person appreciates that in addition to the elements shown in FIG. 1, the mobile device 100 may comprise other elements, such as microphones; displays; as well as additional circuitry such as input/output (I/O) circuitry; memory chips; application-specific integrated circuits (ASIC); processing circuitry for specific purposes such as source coding/decoding circuitry; channel coding/decoding circuitry; ciphering/deciphering circuitry; and the like. Additionally, the mobile device 100 may comprise a disposable or rechargeable battery (not shown) for powering the mobile device 100 if external power supply is not available.

FIG. 2 shows a schematic view of a merge board 100 of an example embodiment. The merge board 100 comprises a header area 110 for a first set of game information, a footer area 130 for a second set of game information, and a grid formed of a plurality of rows 122 and columns 124 to define a plurality of merge item positions 126, only one of which is drawn into FIG. 2 for clarity.

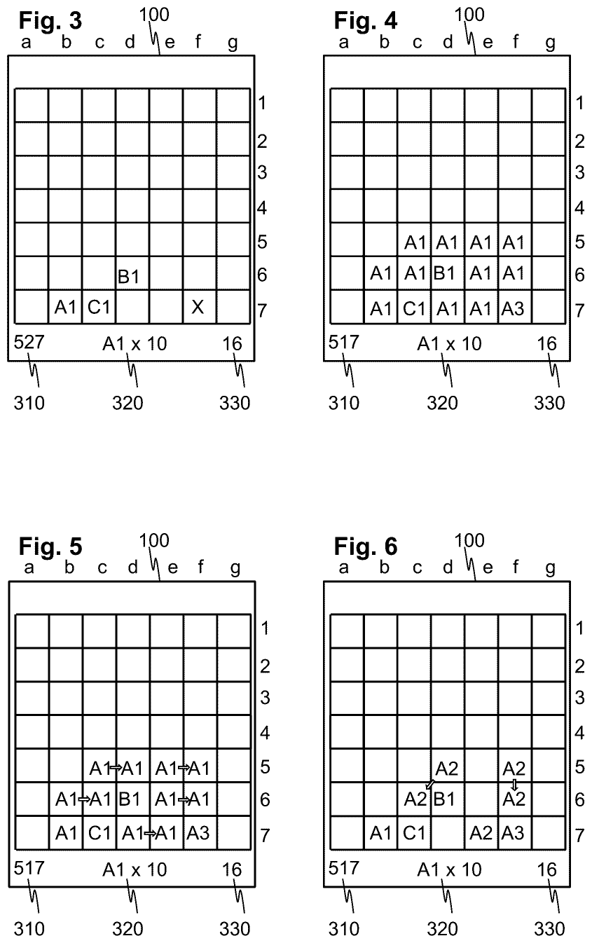

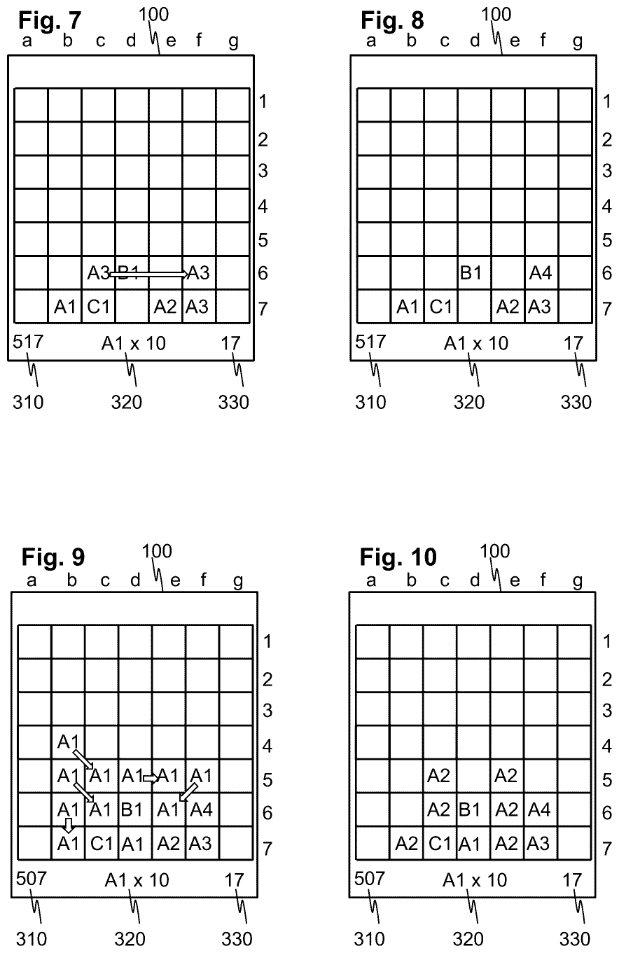

FIGS. 3 to 20 show schematic views of the merge board at different times. For ease of referencing, the grid columns and rows are labelled. For example, in an initial situation shown in FIG. 3, there are first level merge items of chains A, B, and C denoted as A1, B1, and C1 and drawn in positions a7, d6, and b7, respectively.

FIG. 3 further shows some optional controls that inform a user of various states of the game, such as a first indication 310 for virtual energy such as a capping constant having here a value of 527; a second indication 320 that identifies which merge items will be produced and how many, here first level merge items for the chain A; and a third indication 330 illustrating an amount of moves remaining in a game.

FIG. 4 shows a next situation with the ten merge items A1 populated into free positions of the grid. Identical merge items will next be automatically detected and merge, as shown in FIGS. 5 to 8. The arrows indicate how the merging will be conducted.

FIG. 9 shows a situation right after next generation of the merge items, here again ten A1 merge items, how they would populate the grid and the next automatic merging movements, such as merging merge item A1 from position b4 with an identical merge item in b5 so resulting in a merge item of next level of a same chain, here A2. The result of this set of automatic merging operations is shown in FIG. 10.

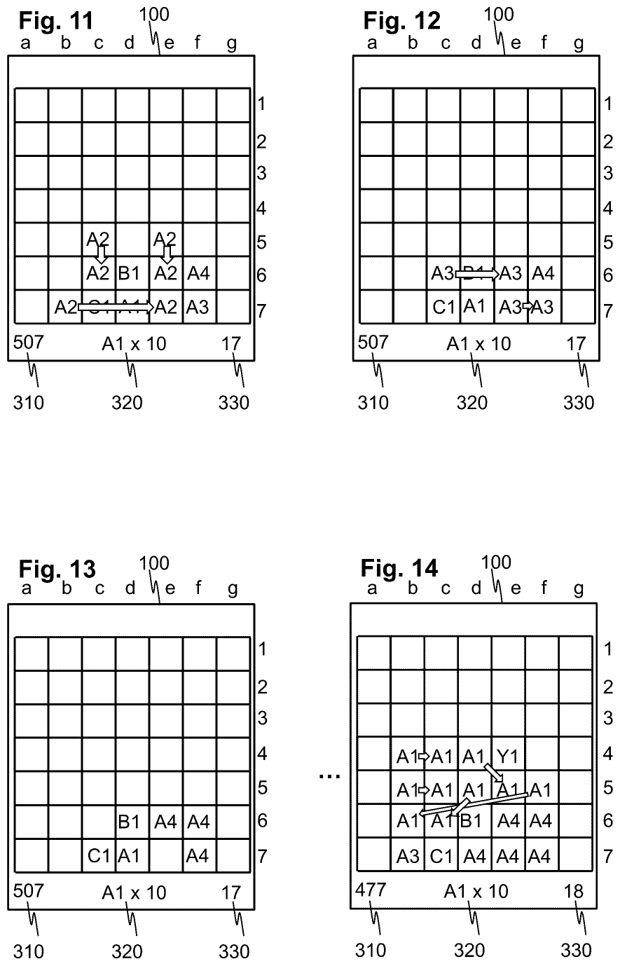

FIGS. 11 to 20 further illustrate various stages and interactions of the merge board 100 according to an example embodiment.

In FIG. 11, the merge board 100 displays next series of automatic merging operations between different second level merge items.

FIG. 12 shows the resulting arrangement after the automatic merging operations drawn in FIG. 11. FIG. 12 further illustrates next merging operations of third level merge items to fourth level merge items. The outcome of these merging operations is shown in FIG. 13.

FIG. 14 shows a non-continuous situation skipping some intermediate merging operations for the sake of brevity. For example, position b7 now accommodates a merge item A3 that is a third level merge item of chain A. Here, further new ten first level merge items are introduced into the grid, as well as arrows indicating the pathways for subsequent merging of identical merge items. In an example embodiment, the automatic merging is started with lowest level merge items in the grid. Advantageously, so generated merge items may then subsequently be merged with other merge items of same level, whereas starting from higher or highest level of merge items could leave some potential merging operations unused.

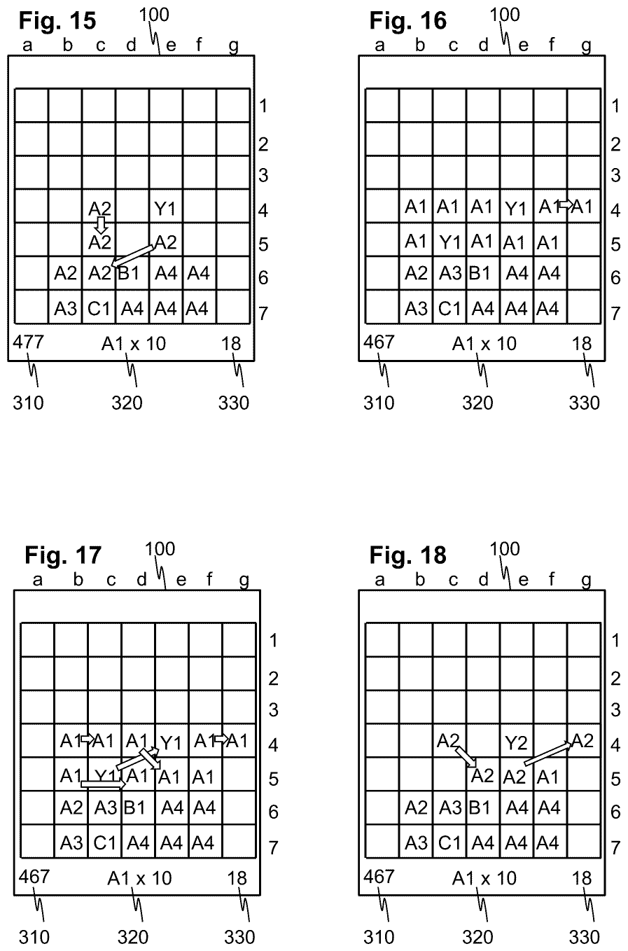

FIG. 15 shows continuation of the merging progress similarly to that shown by FIGS. 3 to 13.

FIG. 16 shows a situation differing from FIG. 14 in that now one of the created merge items is a first level item of a different chain Y, hence drawn as Y1. FIG. 17 shows how this merge item Y1 in c5 is merged with the identical merge item Y1 in e4 so resulting in Y2, that is a second level merge item of chain Y.

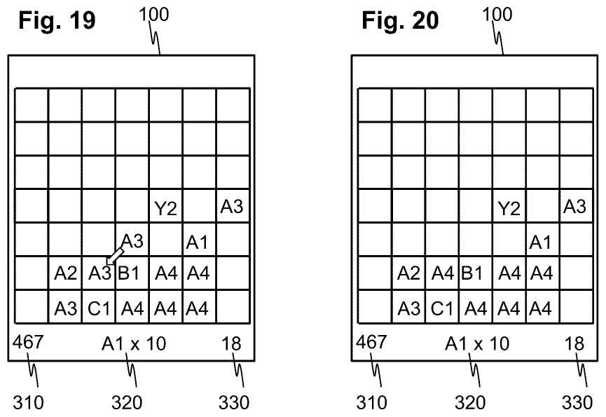

FIG. 18 shows a further intermediate state and next merging operations that result in third level merge items A3 of chain A into positions c5 and g4, one of which is further merged with A3 in b6 as shown in FIGS. 19 and 20.

These drawings collectively demonstrate the dynamic and progressive nature of the merging mechanism of the merge board.

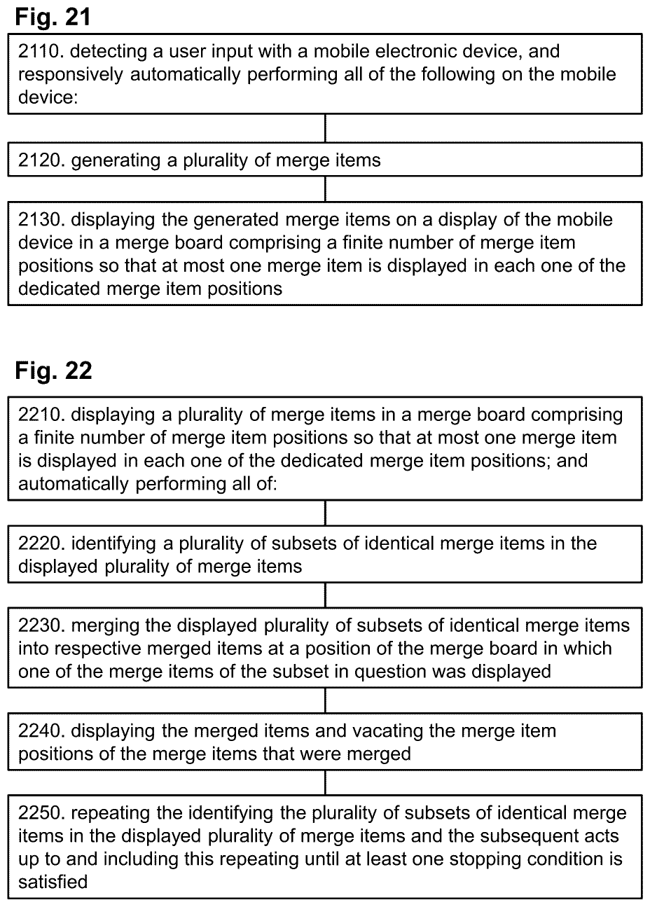

FIG. 21 shows a flow chart of an example embodiment. FIG. 21 illustrates a process comprising various possible steps including some optional steps while also further steps can be included and/or some of the steps can be performed more than once:
2110. detecting a user input with a mobile device, and responsively automatically performing all of the following on the mobile device:
2120. generating a plurality of merge items; and
2130. displaying the generated merge items on a display of the mobile device in a merge board comprising a finite number of merge item positions so that at most one merge item is displayed in each one of the dedicated merge item positions.

In an example embodiment, the method further comprises maintaining a game energy. In an example embodiment, the game energy has an initial value. In an example embodiment, the initial value is a constant. In another example embodiment, the initial value is or comprises a randomised value. In an example embodiment, the game energy constrains that how many merge items are generated responsively to the detecting of the user input.

By generating a plurality of merge items responsively to the detecting of the user input, progression of the game can be improved so that trivial manual actions of the user may be reduced or avoided. A merge game may be significantly accelerated so that effort of the user and increased energy of the mobile device (at least through having a display on instead of a power-saving mode) is not unnecessarily extended.

In an example embodiment, the generating of the plurality of merge items takes place generating the plurality of merge items all at once, in one or more sequences, or generating a first group of merge items at once and the remaining in one or more sequences. In an example embodiment, any sequence of merge items is displayed in the merge board with a user perceivable delay. In an example embodiment, the user perceivable delay is at least 20, 50, or 100 ms. In an example embodiment, the sequence of merge items is displayed as appearing in their respective merge item positions. In another example embodiment, the sequence of merge items is animated to move into their respective merge item positions from a given position in the merge board, such as from a merge item repository. The merge item repository may be fixedly located. Alternatively, or additionally, there may be provided one or more dynamic merge item repositories the position or presence of which is temporally variable.

In an example embodiment, the amount of game energy spent for the generating of the merge items is adaptive. In an example embodiment, the amount of the game energy spent depends on a current spawning mode. In an example embodiment, the spawning mode is implemented using a spawn multiplier. In an example embodiment, the multiplier defines what kind of merge items are to be generated.

In an example embodiment, the amount of energy that the player has at a given time determines the spawn multiplier. In an example embodiment, the spawn multiplier refers to a value that defines how much energy is spent each time the player taps the spawner button (such as a soft key or hard key or virtual button that can be operated by speed, for example). In an example embodiment, when the player taps a spawner button, an amount x of the game energy is spent, wherein x is the multiplier, and up to N merge items are spawned, such as 10. In an example embodiment, N is at least 2, 4, 8, or 10. In an example embodiment, if the multiplier falls within a spawn threshold such as 2, 5, 10, 20, 50, or 100, all the spawned merge items are level 1 items. In an example embodiment, the merge items are then automatically merged after the spawn (by a functionality called to automerge).

In an example embodiment, if the multiplier exceeds the spawn threshold, a number of merge items generated is smaller than the multiplier, e.g., the same as the spawn threshold, but a total value or game energy equivalent of the items equals to the multiplier. In an example embodiment, the value or game energy correspondence of a given merge item is defined by its level. In an example embodiment, a level 1 merge item is valued at 1 unit of game energy, a level 2 merge item has a value of 2 units of game energy, and the values increase onwards in units of game energy as powers of 2, such as 4 for level 3, 8 for level 4, and so on. In an example embodiment, the value of a merge item is 2 to the power of its level −1. For example, in that case, the value of a merge item can be formed for a level 5 item as 2⁽⁵⁻¹⁾=2⁴=16. As another example, at multiplier 20, each tap consumes 20 units of game energy and as a result 10 level 2 items are spawned. Since each level 2 items is worth 2 units of game energy each tap generates items that cost 20 units of game energy in aggregate or in other words the sum of the merge item value is 20.

In an example embodiment, the multiplier can be increased up to 500, 1000, or 2000.

In an example embodiment, the generating of the plurality of merge items is deterministic. In an example embodiment, the number of merge items in the plurality of merge items depends on the game energy.

In an example embodiment, the game energy is increased as a form of rewards. In an example embodiment, the game energy is increased in response to meeting one or more triggering game events, such as having merged a sufficient number of generated merge items. In an example embodiment, a reward is provided randomly in course of spawning new merge items. In an example embodiment, a reward is provided when the player completes a task given in the game. In an example embodiment, a reward is provided when the player completes an event.

In an example embodiment, the plurality of merge items is capped.

In an example embodiment, the capping of the merge items is based on a merging level. In an example embodiment, the merging level is equals to a number of merges that have taken place to create a merge item displayed in the merge board plus one. In other words, a newly generated first merging level merge item is not yet merged, and after first merge, the resulting merge item has a merging level two. In an example embodiment, the amount of the merges has a given maximum. In an example embodiment, the capping is defined as a maximum merge level subtracted by a given capping constant. In an example embodiment, the capping constant is two, three, four, five, six or seven. In other words, the merging may be continued at most until a highest allowable merging level is achieved, which highest allowable merging level is below the maximum merging level by the amount of the capping constant.

In an example embodiment, the capping of the merge items is based on an amount of merge items generated within a predefined duration of time such that exceeding of a given maximum rate is prohibited.

In an example embodiment, the capping of the merge items is removed or relieved at a predefined time for a given relief duration. In an example embodiment, the capping is relieved such that the given maximum of merges is still maintained.

In an example embodiment, the method further comprises merging a subset of identical merge items that are displayed in the merge board. In an example embodiment, the subset consists of two merge items. Advantageously, with two merge items, progress speed can be maximized in comparison to larger subsets.

In an example embodiment, the merge items are generated into two or more different logical chains of different merge items that are logically ordered from a first level merge items to a maximum level merge item. The generating of merge items into two or more different logical chains of different merge items need not occur every time that merge items are generated. In an example embodiment, the generating of merge items into two or more different logical chains of different merge items takes place at least once in M times the merge items are generated. In an example embodiment, M is 100. In an example embodiment, M is 50. In an example embodiment, M is 10.

In an example embodiment, the merge items are generated for a level of merge item that depends on the capping constant. In an example embodiment, the merge items are generated for a single level of merge items. In another example embodiment, some of the merge items are generated for a higher level of merge items.

FIG. 22 shows a flow chart according to an example embodiment. FIG. 22 illustrates a process comprising various possible steps including some optional steps while also further steps can be included and/or some of the steps can be performed more than once:
2210. displaying a plurality of merge items displayed in a merge board comprising a finite number of merge item positions so that at most one merge item is displayed in each one of the dedicated merge item positions; and automatically performing all of:
2220. identifying a plurality of subsets of identical merge items in the displayed plurality of merge items;
2230. merging the displayed plurality of subsets of identical merge items into respective merged items at a position of the merge board in which one of the merge items of the subset in question was displayed;
2240. displaying the merged items and vacating the merge item positions of the merge items that were merged; and
2250. repeating the identifying the plurality of subsets of identical merge items in the displayed plurality of merge items and the subsequent acts up to an including this repeating until at least one of stopping condition is satisfied.

In an example embodiment, the merging of the displayed identical merge items is animated. In an example embodiment, the merging of the displayed identical merge items is emphasised by a sound effect. In an example embodiment, the sound effect depends on the logical level of the merged item that is formed.

One stopping condition is that no further plurality of subsets of the identical merge items is found.

The number of subsets that are merged has a given maximum. One stopping condition is that a game energy is met. The game energy may define a maximum amount of the merged subsets.

In an example embodiment, the maximum for the amount of subsets that are merged depends on a current game energy, wherein the game energy is increasable by the user during playing a merge game in which the merge items are merged. In an example embodiment, the maximum for the amount of subsets that are merged is defined by a multiplier that is formed as a function of the game energy. In an example embodiment, the game energy is increasable by performing the merges. In an example embodiment, the game energy is increasable as rewards for performing challenges or tasks presented by the game to the user. In an example embodiment, the game energy is transactionally increasable, e.g., based on payment made to increase the game energy or consuming advertisements or purchasing goods of game sponsors. In an example embodiment, the game energy is increased as a function of time spent in playing the merge game. In an example embodiment, the game energy is consumed by generating or merging the merge items.

In an example embodiment, the maximum amount of the merged subsets depends on a logical level of the merge items in the merged subsets. In an example embodiment, the merge items of higher logical levels corresponds to merging of a number of first logical level merge items, such as to an exponential amount of the first logical level merge items.

In an example embodiment, one stopping condition is that there are no more subsets of identical merge items below a given highest logical level of the merged items to which automatic merging can be continued. In an example embodiment, the highest logical level of the merged items is dynamically adjustable. In an example embodiment, the highest logical level of the merged items is dynamically adjustable based at least one of: time of day; weekday; context in a game, such as progress of the game; and a supportive event. In an example embodiment, the user is allowed to use achieved or purchased game energy or a direct payment to produce the supportive event.

In an example embodiment, the merging of the plurality of subsets of the identical merge items takes place simultaneously, in one or more sequences, in two or more simultaneous sequences. In an example embodiment, the any sequence of the merging of the displayed plurality of subsets of identical merge items is displayed in the merge board with a user perceivable delay. In an example embodiment, the user perceivable delay is at least 20, 50, or 100 ms.

In an example embodiment, the merging of the plurality of identical merge items is deterministic.

In an example embodiment, the identical merge items is temporarily changed in appearance to enhance operation of the display. In an example embodiment, the appearance is changed by increasing or reducing size of the merge items indicative of merge transition. By temporarily changing the appearance, a relatively small user interface may suffice to clearly illustrate a sequency of events in a short temporal and spatial space.

In an example embodiment, the identical merge items that will be merged is temporarily visually associated, e.g., by displaying an inter-connector therebetween. In an example embodiment, the inter-connector comprises a line between the identical merge items that will be merge.

Any of the methods described in the foregoing are performed automatically so that a fluent sequence of events is formed without significant waiting time, such as 2 or 5 seconds. As such, the methods cannot be implemented by pen and paper, or as a mental act, as it would be impossible to display all required changes in such a fluent manner.

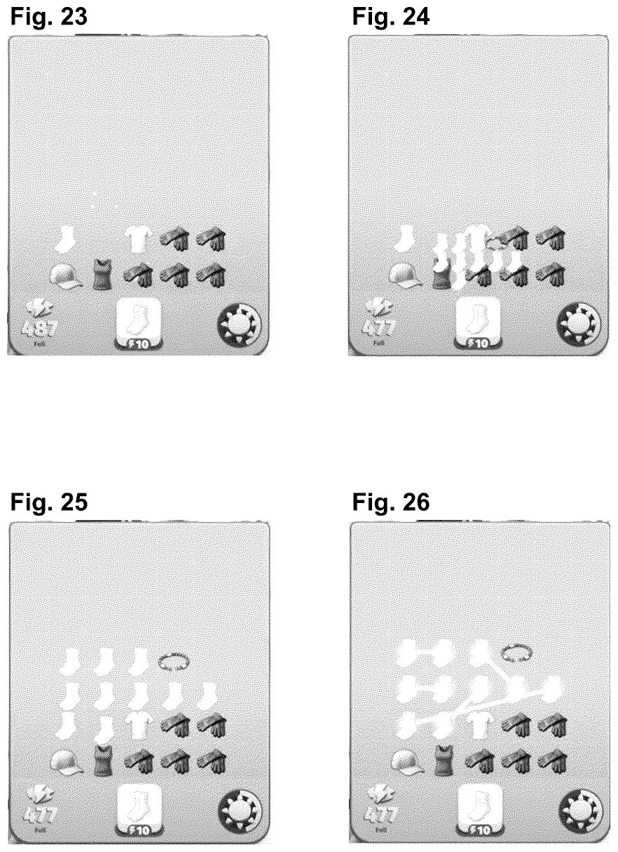

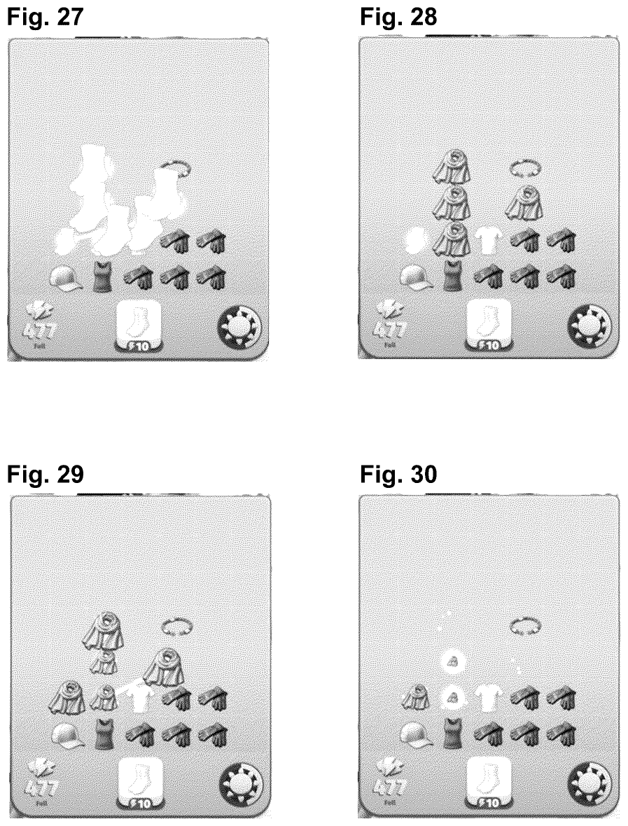

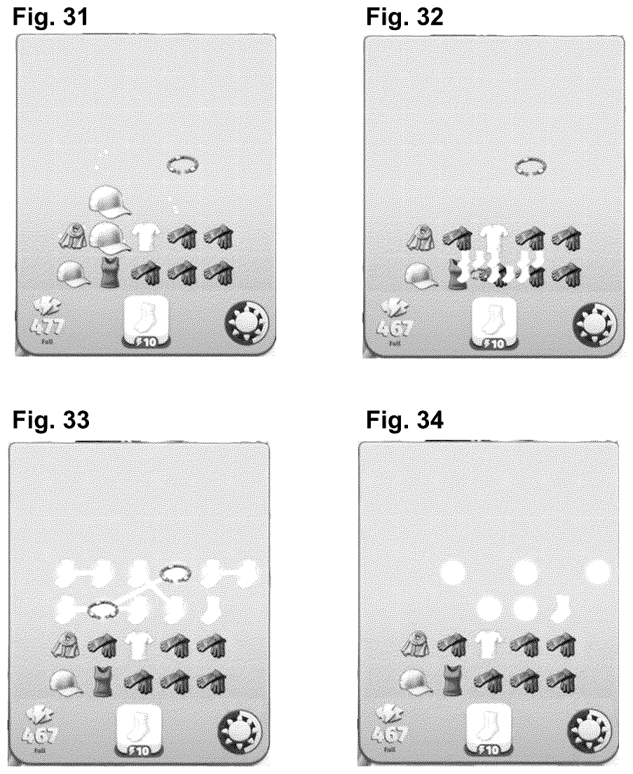

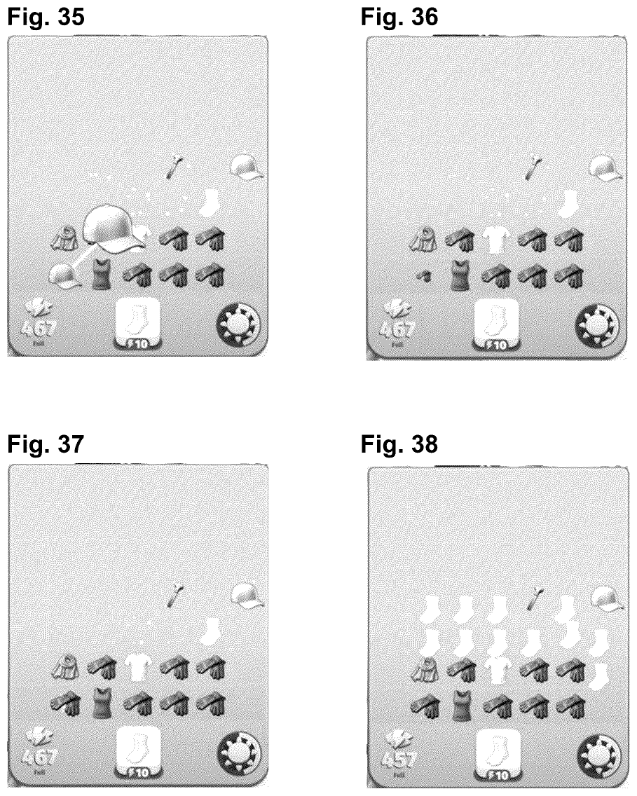

FIGS. 23 to 38 show screenshots illustrating various phases of generating and merging merge items. These drawings exemplify, as seen by the user, generating new merge items, identifying subsets of identical items, merging the identical merge items, and repeating the merging up to a maximum within bounds of the game energy. The game energy may be also referred to as game energy, a parameter that increases, e.g., during progress of game, on succeeding in given missions, with micropayments. Likewise, the generating of merge items may vary depending on the game energy, e.g., such that a virtual cost of generating of merge items is a sum of unit costs of all merge items, wherein the unit cost of each merge item is, e.g., a power of two to the level of the merge item in question. The merging is performed up to meeting at least one stopping criterion. For example, same or a similar cost function may be used in limiting the amount of merging operations as in limiting the generating of the merge items, although in some example embodiments, the merge items are completed to reach a capped maximum level.

FIGS. 23 to 38 collectively highlight various scenarios in which:
A number of new merge items is generated in response to a single user input.
Sets of identical merge items are detected and merged.
Merged items are displayed while vacating positions of the items that were merged.
Identifying of merging pairs and target positions, as well as inception of merged items, are illustrated by changing of appearance including size, surrounding illumination effects, and inter-connectors.

The drawings and corresponding descriptions outline the flexibility and applicability of various embodiments and use cases, demonstrating how the different example embodiments can be applied to achieve efficient generating and merging operations of merge items in a user-interactive environment on a mobile device. It is also demonstrated how the progression of game events can be maintained on a suitably steep curve to make the game interesting and avoiding unnecessary consumption of time and energy to complete a game. In particular, various embodiments may reduce consumption of time and energy to complete a merge game.

Any of the afore described methods, method steps, or combinations thereof, may be controlled or performed using hardware; software; firmware; or any combination thereof. The software and/or hardware may be local; distributed; centralised; or any combination thereof. Moreover, any form of computing, including computational intelligence, may be used for controlling or performing any of the afore described methods, method steps, or combinations thereof. Computational intelligence may refer to, for example, any of artificial intelligence; neural networks; fuzzy logics; machine learning; genetic algorithms; evolutionary computation; or any combination thereof.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A method comprising
detecting a user input with a mobile device, and responsively automatically performing all of the following on the mobile device:
generating a plurality of merge items; and
displaying the generated merge items on a display of the mobile device in a merge board comprising a finite number of merge item positions so that at most one merge item is displayed in each one of the dedicated merge item positions.

2. The method of claim 1, wherein the generating of the plurality of merge items takes place in one or more sequences.

3. The method of claim 1, further comprising maintaining a game energy, wherein the game energy constrains that how many merge items are generated responsively to the detecting of the user input.

4. The method of claim 3, further comprising adapting that how much game energy is spent in the generating of the merge items as a function of the spawning mode, wherein the spawning mode defines a merging level of the merge items that are generated.

5. The method of claim 4, wherein
in a first spawning mode, the generated items are of a first merging level; and
in a second spawning mode, the generated items are of a second merging level or higher, wherein the second and higher merging levels refer to levels achieved by a corresponding sequence of one or more merges.

6. The method of claim 5, wherein
the spawning mode is defined by a spawning multiplier;
in the first spawning mode, a number of the generated merge items equals to a current value of the spawning multiplier; and
in the second spawning mode, the number of the generated merge items is less than a current value of the spawning multiplier and a sum or aggregate of values of the generated merge items equals to a current value of the spawning multiplier.

7. The method of claim 1, further comprising merging a subset of identical merge items that are displayed in the merge board.

8. The method of claim 1, wherein the merge items are generated at least once in M times into two or more different logical chains of different merge items that are logically ordered from a first level merge item to a maximum level merge item, wherein M is 100.

9. The method of claim 1, further comprising
automatically performing a process comprising
identifying a plurality of subsets of identical merge items in the displayed plurality of merge items; and
merging the displayed plurality of subsets of identical merge items into respective merged items at a position of the merge board in which one of the merge items of the subset in question was displayed.

10. The method of claim 9, the process further comprising displaying the merged items and vacating the merge item positions of the merge items that were merged.

11. The method of claim 9, the process further comprising repeating the identifying of the plurality of subsets of identical merge items in the displayed plurality of merge items and the subsequent acts up to and including this repeating until at least one stopping condition is satisfied.

12. The method of claim 9, wherein the merging of the displayed identical merge items is animated.

13. The method of claim 11, wherein one stopping condition is that no further subset of the identical merge items is found.

14. The method of claim 11, wherein one stopping condition is a maximum for an amount of subsets that are merged.

15. The method of claim 11, wherein one stopping condition is that there are no more subsets of identical merge items below a given highest logical level of the merged items to which automatic merging can be continued.

16. The method of claim 15, wherein the highest logical level of the merged items is dynamically adjustable.

17. The method of claim 16, wherein the highest logical level of the merged items is dynamically adjustable based at least one of: time of day; weekday; context in a game, such as progress of the game; or a supportive event.

18. A computer program stored in a non-transitory memory medium, comprising computer executable program code which when executed by at least one processor causes a mobile device to perform the method of claim 1.

19. The computer program of claim 18, further comprising computer executable program code which when executed by at least one processor causes the mobile device to perform a method further comprising the steps of:
automatically performing a process comprising
identifying a plurality of subsets of identical merge items in the displayed plurality of merge items; and
merging the displayed plurality of subsets of identical merge items into respective merged items at a position of the merge board in which one of the merge items of the subset in question was displayed.

20. A mobile device comprising:
at least one memory comprising computer executable program code; and
at least one processor configured cause the mobile device to perform, when executing the program code, at least:
detecting a user input with the mobile device, and responsively automatically performing all of the following on the mobile device:
generating a plurality of merge items; and
displaying the generated merge items on a display of the mobile device in a merge board comprising a finite number of merge item positions so that at most one merge item is displayed in each one of the dedicated merge item positions.
